(19) United States
(12) Patent Application Publication
(10) Pub. No.: US 2013/0119978 A1
(43) Pub. Date: May 16, 2013

(54) INDUCTIVE SENSOR DEVICE AND INDUCTIVE PROXIMITY SENSOR WITH AN INDUCTIVE SENSOR DEVICE

(71) Applicant: Rainer Freise, Braunschweig (DE)

(72) Inventor: Rainer Freise, Braunschweig (DE)

(73) Assignee: SIEMENS AKTIENGESELLSCHAFT, MUENCHEN (DE)

(21) Appl. No.: 13/809,021

(22) PCT Filed: Jul. 5, 2011
(86) PCT No.: PCT/EP2011/061292

§ 371 Date: Jan. 8, 2013

(30) Foreign Application Priority Data
Jul. 8, 2010 (DE) 10 2010 027 017.2

(51) Int. Cl. G01B 7/14

(52) U.S. Cl. 324/207.16

(57) ABSTRACT

An inductive sensor device for detecting a magnetic field change caused by an object approaching in the region of an influencing side of the inductive sensor device includes at least one coil system having a transmitting coil fed with alternating current and first and second receiving coils. The two receiving coils are connected in series in opposite senses, the first receiving coil is disposed in front of the transmitting coil and the second receiving coil is disposed behind the transmitting coil, relative to the influencing side. A screen is provided behind the second receiving coil relative to the influencing side. An inductive proximity sensor with an inductive sensor device is also provided.

The invention relates to an inductive sensor device for detecting a magnetic field change caused by an object approaching in the region of an influencing side of the inductive sensor device, the sensor device comprising at least one coil system having a transmitting coil fed with alternating current as well as a first and a second receiving coil.

Such an inductive sensor device in the form of a wheel sensor for detecting rail-bound wheels is known from the published European patent application EP 0 340 660 A2.

In the case of such wheel or axle counting sensors having separate transmitters and receivers, that is to say usually at least one transmitting coil and at least one receiving coil, the transmitter and the receiver may generally be arranged on the same side or else on different sides of the railway track. A wheel traveling over or past usually produces a reception voltage in the form of a rolling-over curve, which is in the form of a bell curve, in the receiving system of the sensor on account of inductive influence by the wheel or its wheel flange. In this case, depending on the respective polarity and coil arrangement, a wheel is generally deemed to be detected when a fixed switching threshold is exceeded or undershot. Whereas the actual inductive sensor device is necessarily directly arranged on the track in the case of a wheel sensor, an evaluation circuit of the wheel sensor may also be arranged separately from the inductive sensor device, for example in a track connection housing which is usually a few meters away. Irrespective of this, the effective range of inductive sensor devices used in connection with wheel or axle counting sensors is limited to the running range of wheels traveling over.

In addition to rail vehicles, there are also other types of track-bound or track-guided vehicles, for example track-guided vehicles with rubber tires, magnetic levitation trains, overhead conveyors or vehicles which are guided on a single track and are also referred to as a monorail and are used, in particular, in urban railways. In this case too, the operator of the respective vehicles may desire an electronic line clear report which meets high safety requirements. However, since the corresponding vehicles generally do not have any wheels or the latter are not formed from iron or metal, detection of wheels in accordance with the inductive operating principle is usually ruled out in these cases. It would indeed be conceivable, in principle, in this situation to detect or count the vehicles or carriages themselves instead of wheels in order to obtain a statement on the occupancy status of a line section. As an alternative to detecting the vehicles as such, specially oriented metal surfaces could also be fitted to the respective vehicle here, for example, and could be detected using the inductive operating principle. Irrespective of the specific embodiment, however, an inductive sensor device with a considerably greater effective range is required in this case in comparison with conventional wheel or axle counting sensors. The reason for this is that the lateral movement play of a vehicle is usually considerably greater than that of a rail-guided wheel, with the result that a greater distance is required between the inductive sensor device and the object to be detected.

The present invention is based on the object of specifying an inductive sensor device of the type mentioned at the outset which can be used in a flexible and versatile manner.

This object is achieved, according to the invention, by means of an inductive sensor device for detecting a magnetic field change caused by an object approaching in the region of an influencing side of the inductive sensor device, the sensor device comprising at least one coil system having a transmitting coil fed with alternating current as well as a first and a second receiving coil, the two receiving coils being connected in series in opposite senses, the first receiving coil being arranged in front of the transmitting coil and the second receiving coil being arranged behind the transmitting coil based on the influencing side, and a shield being provided behind the second receiving coil based on the influencing side.

Within the scope of the present invention, the “influencing side” is used to refer to that side of the inductive sensor device which, during intended use of the inductive sensor device, is intended to detect the approaching object to the effect that an effective range or detection range within which an object can be detected is formed by the magnetic field in the region of the influencing side. This means that the inductive sensor device is arranged or mounted for its operation in such a manner that the object to be detected moves or approaches in the region of or along the influencing side of the inductive sensor device. In this case, “approach” in the sense of the terms “proximity switch” and “proximity sensor” should generally be understood as meaning that the object to be detected moves relative to the magnetic field, that is to say the effective range, with the result that the presence of the object is ultimately detected by the inductive sensor. For this purpose, it is necessary for the object to be detected to be made of metal or to be electrically conductive.

The invention provides for the two receiving coils to be connected in series in opposite senses, that is to say to be connected to one another in a back-to-back connection. This provides the advantage that the reception voltages induced by the transmitting coil in the two receiving coils largely cancel each other out without influence, that is to say in the absence of an object to be detected. If an object to be detected approaches the sensor device, the magnetic field of the transmitting coil is distorted or changed such that the voltages in the receiving coils no longer cancel each other out. This results in the partial voltages in the receiving coils differing from one another and the resultant voltage change in the receiving coils connected in series being able to be used to detect the object. The back-to-back connection of the two receiving coils therefore considerably increases the immunity of the inductive sensor device to interfering influences. Such an increase in the immunity of the inductive sensor device to interference also provides, in particular, the prerequisite for objects to also be able to be detected in a reliable manner over a greater distance.

The inductive sensor device according to the invention is also distinguished by the fact that the first receiving coil is arranged in front of the transmitting coil and the second receiving coil is arranged behind the transmitting coil based on the influencing side. In other words, the transmitting coil is thus arranged between the first receiving coil and the second receiving coil, the first receiving coil being arranged closer to the influencing side and thus the detection range of the inductive sensor device than the second receiving coil. This means that the function of the second receiving coil is substantially a compensation coil, that is to say is used predominantly to compensate for interference fields. The reason for this is that the second receiving coil is at a greater distance from the influencing side and thus from the detection range of the inductive sensor device than the first receiving coil and therefore is not influenced or is influenced only relatively slightly by the approaching object or the object moving past. In contrast, interference fields will usually influence both receiving coils in a similar manner depending on their origin. Corresponding interference fields may be caused, for example, by power cables running in the vicinity of the sensor device or else by spatially adjacent electrical components, for instance in the form of further sensor devices. On account of the fact that the two receiving coils are connected in series in opposite senses, corresponding interference is thus at least largely compensated for in an advantageous manner.

The inductive sensor device according to the invention is also distinguished by the fact that a shield is provided behind the second receiving coil based on the influencing side. In this case, the shield preferably consists of a diamagnetic material, for instance in the form of a metal. The shield is used to shield the inductive sensor device toward its rear side, that is to say opposite the influencing side, as a result of which any detuning of the inductive sensor device dependent on the respective installation situation, for example as a result of surrounding metal, is precluded. In conjunction with the arrangement of the coils of the coil system and the back-to-back connection of the receiving coils, this advantageously makes it possible to avoid restrictions in terms of the installation location of the inductive sensor device.

Overall, the inductive sensor device according to the invention therefore provides the advantage that it is particularly immune to interference and, on account of this, can be used in a particularly versatile and flexible manner. In this context, it should be pointed out that the arrangement of the transmitting coil and of the receiving coils is also advantageous to the effect that the length of the inductive sensor device or of a housing of the latter along the direction of movement of the object to be detected can be fully used for each of the coils, that is to say both for the transmitting coil and for the two receiving coils. This allows the object to be detected to act over a particularly great length, thus achieving a particularly high degree of sensitivity of the inductive sensor device. In addition, this also provides the prerequisite for the transmitting coil to be able to have a comparatively large diameter, that is to say for example of the order of magnitude of 20 to 30 cm. A correspondingly large diameter of the transmitting coil makes it possible for the inductive sensor device to have a comparatively large detection range. This provides the advantage that it is also possible to detect objects, that is to say for example vehicles, which move past the inductive sensor device or approach the latter at a comparatively large distance. Consequently, the inductive sensor device can also be used in those situations in which the object moves past at a comparatively large distance or different distances may occur between the inductive sensor device and the object to be detected.

The inductive sensor device according to the invention is preferably developed in such a manner that the longitudinal axis of the transmitting coil and/or the longitudinal axis of the first receiving coil and/or the longitudinal axis of the second receiving coil is/are oriented substantially perpendicular to the influencing side. As a result of the fact that the longitudinal axis of at least one of the coils is oriented perpendicular to the influencing side and thus substantially also perpendicular to the conventional direction of movement of the object to be detected, a particularly high degree of sensitivity of the inductive sensor device is achieved. In this case, the longitudinal axes both of the transmitting coil and of the receiving coils are preferably oriented perpendicular to the influencing side.

According to another particularly preferred development, the inductive sensor device according to the invention is designed such that the longitudinal axes of the transmitting coil and the longitudinal axes of the receiving coils substantially correspond. This means that the longitudinal axis of the transmitting coil coincides with that of the two receiving coils. The symmetry in the structure of the inductive sensor device, which is achieved hereby, results, on the one hand, in advantages with regard to the suppression of interference and, on the other hand, also achieves a particularly simple and compact design of the sensor device.

In principle, it is possible for the two receiving coils to be identical in terms of their geometry, their number of turns and their distance from the transmitting coil.

According to another particularly preferred embodiment, the inductive sensor device according to the invention is developed such that the first receiving coil differs from the second receiving coil in terms of its geometry and/or its number of turns and/or its distance from the transmitting coil. This provides the advantage that the respective reception voltages in the receiving coils can be selected in a suitable manner with regard to the respective conditions. Thus, for example, the reception voltage in the respective receiving coil in the quiescent state, that is to say in the uninfluenced state of the inductive sensor device, may be predefined by deliberately adjusting the distance between the transmitting coil and the respective receiving coil.

In principle, it is conceivable for at least one of the coils, in particular the transmitting coil, to have a core. However, in order to avoid magnetic saturation effects, it is generally advantageous if the transmitting coil and/or the first receiving coil and/or the second receiving coil is/are in the form of an air-core coil according to another particularly preferred refinement of the inductive sensor device according to the invention.

The inductive sensor device according to the invention may preferably also be developed such that the transmitting coil and/or the receiving coils is/are each included in a resonant circuit. This provides the advantage that the respective amplitudes of the transmission and reception voltages can be increased and the frequency selectivity can be increased, thus making it possible to further improve the suppression of interference.

Furthermore, the inductive sensor device according to the invention may preferably also be designed in such a manner that a further coil system is arranged in a laterally offset manner with respect to the coil system. This means that the two coil systems are laterally offset with respect to the influencing side in such a manner that temporally offset signals are generated using the two coil systems when the object to be detected approaches. Within the scope of subsequent evaluation of the signals, the direction of movement of the object, that is to say for example the direction of travel of a vehicle, can advantageously be determined in this case.

It is pointed out that, in the case of an inductive sensor device having two coil systems, the shield may be in the form of a component which shields both coil systems or in the form of two components which each shield one of the two coil systems.

The invention also comprises an inductive proximity sensor with an inductive sensor device according to the invention or an inductive sensor device according to one of the abovementioned preferred developments of the inductive sensor device according to the invention and with an evaluation circuit connected to the receiving coils.

The advantages of the inductive proximity sensor according to the invention substantially correspond to those of the inductive sensor device according to the invention or its preferred developments, with the result that reference is made to the corresponding statements above in this respect.

It is also noted that, within the scope of the inductive proximity sensor according to the invention, the inductive sensor device can be connected, in particular, to an evaluation circuit which has already been developed, tested and released in connection with other applications, for example conventional axle counting sensors.

Considerable advantages result from this in terms of complexity and costs, in particular with regard to the conventionally comparatively complicated safety testing of evaluation circuits, as is required, for instance, when inductive proximity sensors are used to report that the track or line is clear. Thus, for example, it is possible to connect an inductive sensor device developed to detect carriages on a monorail to an evaluation circuit originally developed for an axle counting sensor of a wheel/rail system.

The inductive proximity sensor according to the invention is preferably configured such that the inductive sensor device and the evaluation circuit are arranged in different housings. This provides the fundamental advantage that the inductive sensor device and the evaluation circuit can be spatially decoupled. This also facilitates, in particular, the above-described possibility of connecting the inductive sensor device to a type of evaluation circuit which is also used for other applications.

According to another particularly preferred embodiment, the inductive proximity sensor according to the invention is designed to detect track-bound vehicles or to detect parts of track-bound vehicles. This is advantageous since it makes it possible to detect the vehicles, for instance within the scope of a line clear reporting system, in a manner which is particularly immune to interference and is thus particularly reliable, in particular also for track-bound vehicles without wheels. In principle, however, the inductive proximity sensor according to the invention is also suitable for detecting track-bound vehicles with wheels or axles and for detecting the wheels or axles of such vehicles, with the result that the inductive proximity sensor according to the invention can be advantageously used in a versatile manner.

The invention is explained in more detail below using exemplary embodiments. In this respect

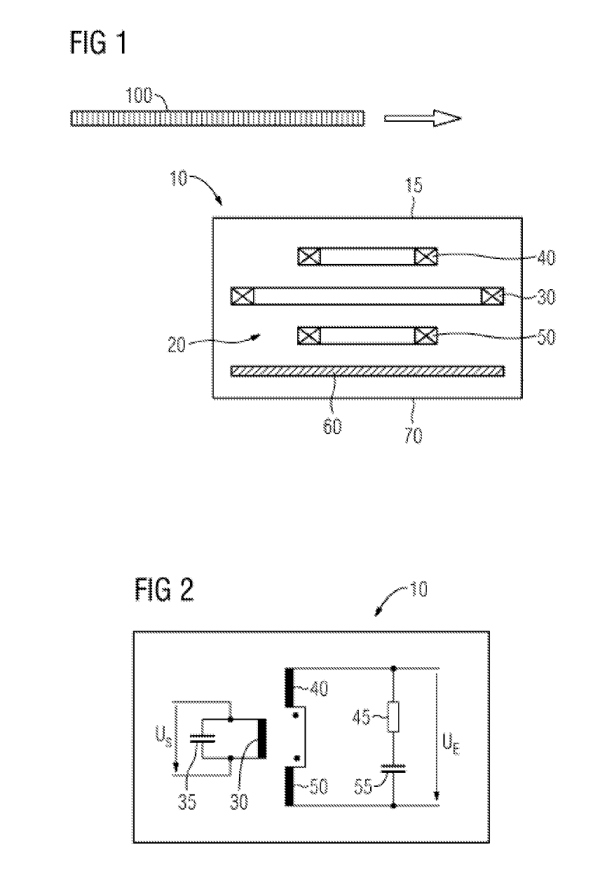

FIG. 1 shows a schematic sectional illustration of an exemplary embodiment of the inductive sensor device according to the invention, and

FIG. 2 shows a schematic circuit diagram of the exemplary embodiment of the inductive sensor device according to the invention.

For reasons of clarity, identical reference symbols are used in the figures for identical components or components which act in a substantially identical manner.

FIG. 1 shows a schematic sectional illustration of an exemplary embodiment of the inductive sensor device according to the invention. The illustration shows an inductive sensor device 10 having an influencing side 15 which is approached by an object 100 or past which an object 100 moves from left to right. The object 100 may be, for example, a carriage or a metal part of a track-guided vehicle.

The inductive sensor device 10 has a coil system 20 consisting of a transmitting coil 30, a first receiving coil 40 and a second receiving coil 50. In accordance with the illustration in FIG. 1, the first receiving coil 40 is arranged in this case in front of the transmitting coil 30 based on the influencing side 15 and the second receiving coil 50 is arranged behind the transmitting coil 30 based on the influencing side 15. It is assumed that the two receiving coils 40, 50 are connected in series in opposite senses in order to suppress interference fields, that is to say are connected to one another in a back-to-back connection.

The inductive sensor device 10 also has a shield 60 which, within the scope of the exemplary embodiment described, is intended to be a diamagnetic metal plate. Based on the influencing side 15, the shield 60 is provided behind the second receiving coil 50, that is to say in the direction of the rear side of the inductive sensor device that is opposite the influencing side 15. The shield 60 advantageously shields the coil system 20 of the inductive sensor device 10 towards the rear side in such a manner that external interfering influences are reduced or avoided.

In accordance with the illustration in FIG. 1, the coil system 20 and the shield 60 are accommodated in a housing 70.

If the object 100, which may be a metal plate for example, now enters the detection range of the inductive sensor device 10, the field of the transmitting coil 30 is distorted in such a manner that the voltages in the receiving coils 40, 50 become different or become more different. Consequently, the voltage change in the receiving coils 40, 50 connected in series can be used to detect objects 100 in the form of metal surfaces or metal parts which may be, for example, a chassis or a carriage wall of a track-bound vehicle. The shield 60 deflects the magnetic field lines to an increased extent, with the result that, with the same geometry of the receiving coils 40, 50, the distance between the latter and the transmitting coil 30 can be selected differently in order to compensate for the reception voltages in the quiescent state, that is to say in the uninfluenced state of the inductive sensor device 10.

In order to detect objects 100 which are further away, the transmitting coil 30 has a diameter of a suitable size. Depending on the respective conditions, the diameter may be of the order of magnitude of approximately 20 to 50 cm for example in this case. However, smaller or larger diameters of the transmitting coil 30 are also possible. In addition, a structure with a further corresponding coil system may also be expedient, thus making it possible to detect the direction of movement of the object 100.

In the exemplary embodiment in FIG. 1, the longitudinal axes of the transmitting coil 30 and of the receiving coils 40 and 50 coincide and are oriented perpendicular to the influencing side 15, that is to say also perpendicular to the direction of movement of the object 100 in the exemplary embodiment illustrated. The transmitting coil 30 and the receiving coils 40, 50 are in the form of air-core coils in order to avoid possible interfering influences caused by saturation effects of a coil core.

FIG. 2 shows a schematic circuit diagram of the exemplary embodiment of the inductive sensor device according to the invention. In this case, the inductive sensor device 10 is indicated only schematically for the purpose of illustrating a simplified circuit diagram of the inductive sensor device.

In accordance with the illustration in FIG. 2, the transmitting coil 30 and the receiving coils 40 and 50 connected to one another in a back-to-back connection are each included in a resonant circuit to the effect that the transmitting coil 30 forms, together with a capacitor 35, a transmitting resonant circuit. In a similar manner, the receiving coils 40, 50 also form, with a resistor 45 and a capacitor 55, a receiving resonant circuit. In this case, U_{S} in FIG. 2 is used to denote the transmission voltage in the transmitting resonant circuit and U_{E} is used to denote the reception voltage in the receiving resonant circuit. Depending on the respective conditions, the root-mean-square value of the transmission voltage U_{S} may be of the order of magnitude of 30 to 60 V, for example, and the root-mean-square value of the reception voltage U_{E} may be considerably below 1 V, for example, in the quiescent state, that is to say in the absence of an object to be detected. Designing the transmitter and the receiver as resonant circuits advantageously increases the frequency selectivity, thus suppressing interference at a different frequency.

The inductive sensor device described above can be used, together with a corresponding evaluation circuit which is connected to the receiving resonant circuit, to implement an inductive proximity sensor. In this case, it is possible to also use an already available evaluation circuit or evaluation electronics, which demonstrably meet(s) the high safety requirements in the field of track clear reporting for example, for the corresponding inductive proximity sensor, in particular also as a result of the fact that the inductive sensor device and the evaluation circuit can be arranged spatially separately from one another in different housings, in order to detect trains or automobiles or parts of the latter, for example, instead of wheels or axles. The inductive sensor device described is therefore not only particularly robust with respect to interfering influences but furthermore can also be used in a particularly flexible and versatile manner.

1-10. (canceled)

11. An inductive sensor device for detecting a magnetic field change caused by an approaching object, the sensor device comprising:
an influencing side in vicinity of which the object approaches;
at least one coil system having a transmitting coil fed with alternating current and first and second receiving coils connected in series in opposite senses;
said first receiving coil disposed in front of said transmitting coil and said second receiving coil disposed behind said transmitting coil, relative to said influencing side; and
a shield disposed behind said second receiving coil relative to said influencing side.

12. The inductive sensor device according to claim 11, wherein said transmitting coil, said first receiving coil and said second receiving coil have respective longitudinal axes, and at least one of said longitudinal axes is oriented substantially perpendicular to said influencing side.

13. The inductive sensor device according to claim 11, wherein said transmitting coil, said first receiving coil and said second receiving coil have respective longitudinal axes, and said longitudinal axis of said transmitting coil and said longitudinal axes of said receiving coils substantially correspond.

14. The inductive sensor device according to claim 11, wherein said first receiving coil differs from said second receiving coil in terms of at least one of geometry or number of turns or distance from said transmitting coil.

15. The inductive sensor device according to claim 11, wherein at least one of said transmitting coil or said first receiving coil or said second receiving coil is an air-core coil.

16. The inductive sensor device according to claim 11, which further comprises a resonant circuit including at least one of said transmitting coil or said receiving coils.

17. The inductive sensor device according to claim 11, which further comprises a further coil system disposed laterally offset with respect to said coil system.

18. An inductive proximity sensor, comprising:
an inductive sensor device according to claim 11; and
an evaluation circuit connected to said receiving coils.

19. The inductive proximity sensor according to claim 18, wherein said inductive sensor device and said evaluation circuit are disposed in different housings.

20. The inductive proximity sensor according to claim 18, wherein the inductive proximity sensor is configured to detect track-bound vehicles or to detect parts of track-bound vehicles.
